(19) United States
(12) Patent Application Publication
(10) Pub. No.: US 2007/0098860 A1
(43) Pub. Date: May 3, 2007

(54) Post-roast infusion of vegetable and fruit pieces

(75) Inventors: Jolene E. Cram, Nampa, ID (US); Alan T. Gilmore, Caldwell, ID (US); Allen J. Neel, Nampa, ID (US); David B. Walker, Meridian, ID (US); Ronald B. Bates, Boise, ID (US)

Correspondence Address: KELLY LOWRY & KELLEY, LLP, 6320 CANOGA AVENUE, SUITE 1650, WOODLAND HILLS, CA, 91367, US

(73) Assignee: J.R. SIMPLOT COMPANY

(21) Appl. No.: 11/523,966

(22) Filed: Sep. 19, 2006

Related U.S. Application Data
(60) Provisional application No. 60/731,567, filed on Oct. 28, 2005.

(51) Int. Cl. A23L 1/01

(52) U.S. Cl. 426/438

(57) ABSTRACT

Vegetable or fruit pieces such as potato wedges or chunks and the like are blanched and then roasted. The post-roast pieces are then infused with liquid preferably such as an aqueous solution as by spraying or dipping to result in a post-roast product weight increase on the order of up to about 20% by weight, followed by freezing for shipment and/or storage. This invention enhances process control by providing a means of independent control of color development and moisture. The thus-prepared and frozen potato pieces are suitable for subsequent finish preparation as by finish frying or oven heating, resulting in a finish-prepared product having a desirable combination of taste, texture and appearance attributes. The invention is not limited to potatoes but includes other vegetables and fruits as well.

This application claims benefit of copending U.S. Application No. 60/731,567, filed Oct. 28, 2005.

### BACKGROUND OF THE INVENTION

This invention relates generally to an improved process for preparing roasted potato pieces suitable for finish preparation with a combination of highly desirable taste, texture and appearance characteristics. More specifically, this invention relates to an improved process and the resultant roasted potato pieces, wherein the potato pieces are subjected to a post-roast liquid infusion step.

Roasted vegetable products particularly such as potatoes are known in the art, wherein vegetables pieces in cut form are subjected to a roasting step to produce finish-cooked products having a distinctive and desirable combination of visual and organoleptic properties. For example, potato pieces are often roasted by subjecting cut raw potatoes in a peeled or unpeeled state to dry heat as in an oven or by exposing the potato pieces to a flame or heated coals, for cooking the potato pieces substantially to completion. Such potato pieces, when cut from raw potatoes, typically comprise potato wedges or chunks and the like, or a combination of different-shaped potato pieces having an approximately uniform overall size. The finish-cooked potato pieces normally exhibit a relatively dry and sometimes shell-like cooked exterior of typically dark golden brown color which encases a preferably moist and mealy cooked interior. In many cases, such potato pieces are roasted alongside other food items such as meat and/or poultry products, and thus tend to pick up some flavor attributes therefrom.

Potato processors have developed roasted potato products wherein potato pieces are subjected to a roasting step for partial cooking thereof, and then frozen for shipment and/or storage before finish preparation, e.g., at a restaurant or other food service facility immediately prior to serving the roasted potato products for consumption. Such processed, partially-cooked roasted potato products are designed for relatively rapid finish preparation, as by means of oven heating or short-cycle finish frying or the like, thereby permitting a small or selected quantity of products to be finish-prepared quickly and easily on an as-needed basis.

Processed roasted potato products are typically prepared by initially blanching cut potato pieces in hot water or steam, followed by subjecting the blanched pieces to a roasting step before freezing. Topical seasonings such as oils, flavorings, and the like are sometimes added to the surfaces of the roasted pieces after freezing for purposes of imparting selected flavor attributes. However, such surface-applied flavorings and the like do not adhere well to the roasted pieces during subsequent storage and eventual finish preparation processes. In addition, during the roasting step, the cooked exterior of the potato pieces can become undesirably dry and tough, resulting in a finish-prepared product that lacks an optimal combination of taste, texture and appearance characteristics.

Current roasting processes create browning and sometimes remove more moisture than is desirable for product quality and process recovery. Also, the variable raw potato solids have an effect on the final moisture. A low solids, higher moisture potato is more desirable for roasting to achieve color and moisture target. Roasting a higher solids, lower moisture potato can result in lower than desirable moisture levels when optimal color is achieved. Currently, independent control of color development and moisture removal is difficult to achieve. The graph below shows the relationship of raw potato solids, roasted product moisture and roasted product weight loss.

[image]

There exists, therefore, a need for further improvements in and to processes for preparing roasted vegetable products such as potatoes, wherein roasted and frozen product pieces are designed for quick and easy finish preparation with a consistently desirable and substantially optimized set of organoleptic properties. The present invention fulfills these needs and provides further related advantages.

### SUMMARY OF THE INVENTION

In accordance with the invention, vegetable pieces such as raw cut potato wedges and/or chunks are initially blanched and then roasted.

The roasted pieces are then surface-infused with liquid preferably such as an aqueous solution as by spraying or dipping, to result in a product weight increase on the order of up to about 20% by weight, followed by freezing for shipment and/or storage. The thus-prepared potato pieces are suitable for subsequent finish preparation as by finish frying or oven heating, resulting in finish-prepared pieces having a desirable combination of taste, texture and appearance attributes.

In one preferred process, the cut potato pieces in a raw state are blanched in hot water or steam, as by water blanching in hot water having a temperature of about 160° to about 190° F., for a time period of about 2 to 15 minutes. The blanched potato pieces are then subjected to a roasting step as by heating in an oven at a temperature of about 400° to about 600° F., for a time period of about 1 to 15 minutes. The thus-roasted potato pieces are then surface-infused with liquid as by dipping or spraying preferably with an aqueous solution which may include selected flavor constituents. The infusion liquid quickly absorbs into the external layer of the roasted products, producing a product weight increase on the order of up to about 20% by weight. The liquid-infused roasted products are then frozen for packaging and appropriate shipment and/or storage.

The liquid-infused roasted products are suitable for finish preparation as by oven heating or short-cycle finish frying. The finish prepared products exhibit a desirable set of taste, texture and appearance characteristics closely emulating potato pieces which have been cooked by roasting from a raw state.

Other features and advantages of the present invention will become apparent from the following more detailed description.

### DETAILED DESCRIPTION OF THE PREFERRED EMBODIMENT

The present invention relates to an improved process for preparing roasted and frozen vegetable pieces such as potato pieces suitable for relatively quick and easy finish preparation as by oven heating or short-cycle finish frying. The product pieces may be initially and optionally blanched and then subjected to a dry heat roasting step, followed by surface infusion of liquid such as water before freezing for shipment and/or storage. Thereafter, upon finish preparation, the roasted products exhibit a desirable combination of taste, texture and appearance attributes.

The post-roast liquid infusion step results in a substantial infusion or uptake of liquid which is believed to absorb quickly into the otherwise relatively dry external region of each product piece, resulting in significantly enhanced product moisture and accompanying product weight increase on the order of up to about 20% by weight. This invention enhances process control by providing a means of independent control of moisture removal and color development. This invention enables roasting to the desired color and provides a means to add back water to achieve the desired moisture level required for substantially optimum organoleptic properties. In one preferred form, the infusion liquid comprises pure water, although persons skilled in the art will understand and appreciate that selected flavoring constituents, color, solution pH adjusted, and/or seasoning elements may be added to the infusion liquid. Alternately, if desired, the infusion liquid may further incorporate or comprise oil constituents. Upon finish preparation, the post-roast infusion step provides significant improvements in and to overall product characteristics including but not limited to improved flavor, color, moistness and texture.

In accordance with one preferred form of the invention, peeled or unpeeled raw potato pieces are cut into potato wedges or chunks, or a combination thereof, preferably having an approximately uniform overall size. The potato pieces are initially blanched in hot water or steam to partially cook the potato pieces, as by blanching in hot water having a temperature within the range of from about 160° to about 190° F., for a time period of about 2 to about 15 minutes, depending on the cut size and solids, and more preferably at a temperature of about 185° F. for a time period of about 5 minutes for an 8 cut wedge cut into ˜⅝″ chunks. The blanched potato pieces are then removed from the blanch medium and drained of excess water.

The blanched potato pieces are next subjected to a roasting step wherein the potato pieces are partially cooked by exposure to dry heat, e.g., within an oven or by exposure to a flame or heated coils. In one preferred process, the blanched potato pieces are roasted in an oven which is heated to a temperature within the range of from about 400° to about 600° F. and preferably about 400-475° F., for a time period of about 1 to 15 minutes, and preferably about 7-9 minutes. The roasted potato pieces exhibit a golden brown mottled appearance, slightly tough exterior, roasted flavor, with mealy and moist interior to mealy and dry interior.

The thus-roasted potato pieces are then infused with the selected infusion liquid, preferably such as water or an aqueous-based solution. The infusion liquid is applied to the roasted potato pieces as by dipping or spraying, wherein the infusion liquid is absorbed quickly by the roasted and dry exterior surfaces of the potato pieces. In the preferred form, the infusion step results in a substantial intake of liquid which infuses a significant distance through and beyond the roasted exterior surfaces, resulting in a significant product weight gain attributable to infused moisture. Such weight gain is on the order of up to about 20% by weight, and more preferably about 1-16% by weight. The graphs below illustrate the relationship of water uptake at various water temperatures, effect of rehydration time, and salt uptake.

The data in Graph 1 shows the water treatment was effective for a temperature range of 40° F. to 150° F. and possibly higher. In this test, roasted chunks of potatoes were dipped in 6% (by weight) salt solution at the three temperatures for 10 seconds. Roasted potatoes with two different roaster weight losses were tested, 25% and 35%. The dip water temperature range of 40° F. to 150° F. resulted in like roasted potato product having about the same moisture, within about 1% final moisture. The fact that moisture can be increased in the roasted product allows for another avenue to control finished product moisture.

[image]

Graph 2 below shows the water spray contact time vs. dip time may both increase percent moisture in the final product. The water spray may not be as effective in moisture pickup as the dip for the same time. A dip time in 70° F. water for one minute has about the same moisture increase as a five minute dip.

[image]

Graph 3 below shows that either process improves product recovery.

[image]

Graph 4 below shows the relationship of roasted product weight loss during roasting, salt pick up, and dip water temperature. The roasted potatoes were dipped in a 6% salt solution for 10 seconds. The dip water temperature had little effect on salt pick up. As product roaster weight loss increased the salt concentration increased in the product. The salt absorption demonstrates that other water soluble flavors or colors may be absorbed in the roasted product.

[image]

In an infusion liquid spray system, the infusion liquid can be applied to the roasted potato pieces by means of an overhead spray manifold directing the infusion liquid downwardly onto the roasted products which may be carried on a conveyor exiting the roast step, as described above. Over-spray can be recycled, or discarded. In an infusion liquid dip system, the roasted potato pieces can be conveyed continuously or dipped in batches into an infusion liquid bath.

The liquid-infused roasted potato pieces are then frozen for further handling in the course of packaging for shipment and/or storage awaiting finish preparation, e.g., at a restaurant or other food service facility. The roasted and liquid-infused frozen product pieces may be enrobed with a surface film of cooking oil. Other seasonings and flavoring elements may be applied to the product external surfaces.

The roasted and frozen potato pieces may be finish prepared by alternative methods such as oven heating or finish frying and the like. By way of example, in one preferred oven heating finish preparation process, the potato pieces are heated in a convection oven set at a temperature within the range of from about 350° F. to about 400° F., and more preferably about 375° F., for a time period of about 5 to 15 minutes, and more preferably about 10 minutes. The finish-prepared potato pieces exhibit a highly desirable combination of overall taste, texture and appearance characteristics closely similar to traditional roasted potatoes which have been finish cooked by roasting from a raw state. One desirable quality is the skin toughness has been reduced.

Alternatively, in one preferred finish fry preparation process, the potato piece are fried in hot oil having a temperature within the range of from about 340° F. to about 370° F., for a time of about 2 to 4 minutes.

One example of the process:
1. Unpeeled potatoes are cleaned and inspected and cut into random chunks.
2. The potato pieces are water blanched for 5 minutes @ 185° F. with 0.5% (by weight) sodium acid pyrophosphate.
3. The blanched potato pieces are dipped in a 2% (by weight) dextrose solution for 20 seconds about 150° F. The blanched potato pieces have a slightly raw and boiled potato flavor with a slightly crunchy texture.
4. The blanched potato pieces are roasted for 9 minutes, at about 400° F. to about 450° F. with the air flow about 270 ft/min. The roasted potato pieces exhibit a golden brown mottled appearance, slightly tough exterior, roasted flavor, with moist mealy or dry mealy interior texture.
5. The roasted potato pieces travel on a conveyor belt under an intermittent ˜70° F. water spray system for about 20 seconds of total spray time. Water is applied about 0.13 gallons per minute per nozzle. The number of spray nozzles may vary depending on the degree of rehydration. The quality is the same as in step 4 with a slightly less tough potato surface and higher moisture.
6. The potato pieces are frozen and packaged. The baked frozen product has a softer external texture than a non-water treated roasted product. The internal texture is in the range of moist and mealy to dry and mealy.

Although an embodiment has been described in detail for purposes of illustration, various modifications may be made without departing from the scope and spirit of the invention. In this regard, while the preferred embodiment is described in connection with potato pieces such as wedges and chunks, persons skilled in the art will understand and appreciate that alternative potato piece shapes including but not limited to strips may also be used. In addition, it will be recognized that other types of vegetable or fruit products may be processed according to the invention. Accordingly, no limitation on the invention is intended by way of the foregoing description, except at set forth in the appended claims.

What is claimed is:

1. A process for preparing a roasted and frozen food product, comprising the steps of:
cutting a food product selected from the group consisting essentially of fresh vegetables and fresh fruits into a plurality of pieces;
roasting the cut pieces;
infusing external surfaces of the roasted cut pieces with an aqueous solution; and
freezing the roasted and infused cut pieces.

2. The process of claim 1 wherein said cutting step comprises cutting a fresh vegetable.

3. The process of claim 2 wherein said fresh vegetable comprises a potato.

4. The process of claim 1 wherein the cut food product pieces have an approximately uniform overall size.

5. The process of claim 4 wherein the cut food product pieces comprise chunks.

6. The process of claim 1 further including the step of blanching the cut food product pieces prior to said roasting step.

7. The process of claim 1 wherein said roasting step comprises subjecting the cut food product pieces to relatively dry heat.

8. The process of claim 1 wherein said infusing step comprises dipping the roasted cut food product pieces into said aqueous solution.

9. The process of claim 1 wherein said infusing step comprises spraying the aqueous solution onto the roasted cut food product pieces.

10. The process of claim 1 further including the step of adding a flavor constituent to the aqueous solution.

11. The process of claim 1 wherein said infusing step results in a roasted cut food product piece weight increase up to about 20%.

12. The process of claim 11 wherein said infusing step results in a roasted cut food product piece weight increase of from about 1% to about 16%.

13. The process of claim 1 wherein said roasting step continues at a time and temperature sufficient to produce roasted cut food product pieces having a target surface color, and further wherein said infusing step results in a food product weight increase sufficient to achieve a target moisture content.

14. Roasted and frozen food product pieces prepared in accordance with the process of claim 1.

15. A process for preparing a roasted and frozen potato pieces, comprising the steps of:
cutting potatoes into a plurality of pieces;
blanching the cut potato pieces;
roasting the cut potato pieces at a time and temperature sufficient to achieve a target surface color;
infusing external surfaces of the roasted cut potato pieces with an aqueous solution to achieve a target moisture content; and
freezing the roasted and infused cut potato pieces.

16. The process of claim 15 wherein said cutting step comprises cutting raw potatoes into chunks of approximately uniform overall size.

17. The process of claim 15 wherein said blanching step comprises partially cooking the cut potato pieces in a blanching medium selected from the group consisting essentially of hot water and steam.

18. The process of claim 15 wherein said roasting step comprises heating the blanched potato pieces in an oven.

19. The process of claim 15 wherein said infusing step comprises surface application of the aqueous solution by dipping to achieve a roasted potato piece weight increase of up to about 20%.

20. The process of claim 15 wherein said infusing step comprises surface application of the aqueous solution by spraying to achieve a roasted potato piece weight increase of up to about 20%.

21. The process of claim 15 further including the step of adding a flavor constituent to the aqueous solution.

22. The process of claim 15 further including the step of finish preparation of the roasted and frozen potato pieces by finish frying.

23. The process of claim 15 further including the step of finish preparation of the roasted and frozen potato pieces by oven heating.

24. Roasted and frozen potato pieces prepared in accordance with the process of claim 15.
